(19) United States
(12) Patent Application Publication
(10) Pub. No.: US 2021/0385549 A1
(43) Pub. Date: Dec. 9, 2021

(54) VIDEO TRANSMITTING DEVICE

(71) Applicant: LG ELECTRONICS INC., Seoul (KR)

(72) Inventor: Dongsung KIM, Seoul (KR)

(73) Assignee: LG ELECTRONICS INC., Seoul (KR)

(21) Appl. No.: 17/285,419

(22) PCT Filed: Dec. 20, 2018
(86) PCT No.: PCT/KR2018/016356

§ 371 Date: Apr. 14, 2021

(51) Int. Cl. H04N 21/6373

(52) U.S. Cl. CPC H04N 21/6373

(57) ABSTRACT

A video transmitting device includes a processor to extract a logo image from an entire content image, when the entire content image including a content image and the logo image is a moving picture image, to determine a compression ratio of the content image to be a first compression ratio and a compression ratio of the logo image to be a second compression ratio higher than the first compression ratio, a content compressing unit to compress the content image at the first compression ratio and to compress the logo image at the second compression ratio, based on the determined compression ratio, and a wireless communication unit to wirelessly transmit the compressed content image and the compressed logo image to a video receiving device.

### TECHNICAL FIELD

The present invention relates to a video transmitting device capable of compressing and transmitting an image.

### BACKGROUND ART

As a video technology has changed from an analog scheme to a digital scheme, the image technology has been developed from Standard-Definition (SD) to Hi-Definition (HD) in order to provide images closer to actual images. The SD supports 704×480 resolution and includes about 350,000 pixels. The HD is divided into HD and Full HD. The Full HD for supporting higher resolution supports 1920×1080 resolution and includes 2 million pixels to provide a significantly higher image-quality as compared to those of the SD.

Recently, the video technology has be grown in one step to UHD (Ultra High-Definition (UHD) beyond the above-mentioned Full HD, and the UHD supporting ultra-high image quality and ultra-high resolution has attracted attention as a next generation media environment. The UHD supports 4K (3840×2160) and 8K (7680×4320) resolutions and supports the surround audio of up to 22.2 channels. Such a UHD provides image quality 4 times sharper than the image quality of the 4K UHD standard, and the 8K UHD provides image quality 16 times sharper than the HD.

Meanwhile, such a UHD image may include a logo for representing a producer or a title of the image. The logo is continuously displayed at a fixed position for a specific period of time.

When a logo region is displayed through an organic light emitting display, pixels of that logo region in which a logo is positioned are driven to express the same brightness and color for a long time even if a screen is changed.

Accordingly, there is a problem that a residual image of the logo remains even if the screen is changed in the logo region.

Further, an organic light emitting element included in each pixel of the logo region is subject to the stress greater than a remaining region other than the logo region.

That is, the organic light emitting element in the logo region may be more deteriorated as compared with the other organic light emitting elements in the remaining region other than the logo region.

Conventionally, the problems of the residual image and the deterioration have been solved by extracting a logo region from a content image and lowering the brightness of the extracted logo region.

However, when the brightness of the logo region is lowered, the brightness of the logo region is decreased, thereby reducing the visibility of the viewer.

### DISCLOSURE

### Technical Problem

Accordingly, the present invention has been made keeping in mind the above problems occurring in the prior art, and an object of the present invention is to provide a video transmitting device capable of improving a residual image of a logo image by transmitting an image by making a compression ratio of an entire content image different from a compression ratio of a logo image.

An object of the present invention is to provide a video transmitting device capable of adaptively transmitting an image by adjusting a compression ratio of a logo image, depending on a wireless image quality status.

### Technical Solution

In order to accomplish the objects, according to one aspect of the present invention, there is provided a video transmitting device may transmit an image to a video receiving device by compressing the entire content image at a first compression ratio and compressing a logo image at a second compression ratio.

According to another aspect of the present invention, the video transmitting device may determine the compression ratio of the logo image depending on whether the detected wireless quality status exceeds reference quality.

### Advantageous Effects

According to the embodiment of the present invention, the compression ratio of the logo image may be increased as compared with the compression ratio of the content image, thereby reducing the residual image for the logo image. Accordingly, deterioration of the pixels corresponding to the position at which the logo image is displayed may be reduced.

### DESCRIPTION OF DRAWINGS

FIGS. 1 to 3 are views illustrating a configuration of a display system, according to an embodiment of the present invention.

FIG. 4 is a ladder diagram illustrating a method for operating a display system, according to an embodiment of the present invention.

FIG. 5 shows an example of a logo image located on an entire content image.

FIG. 6 is a view illustrating a process of extracting and compressing a logo image from an entire content image, according to an embodiment of the present invention.

FIG. 7 is a view illustrating a process of compressing a content image and a logo image, according to an embodiment of the present invention.

FIG. 8 is a view illustrating the actual change of a logo image when the compression ratio of the logo image is varied, according to an embodiment of the present invention.

### MODE FOR INVENTION

Hereinafter, an embodiment of the present invention will be described with reference to drawings. The suffix “module” and “ part” for components used in the following description are given or mixed only for the illustrative purpose, and do not have mutually different meanings or roles.

According to the embodiment of the present invention, a video transmitting device, which serves as an intelligent device having a broadcast receiving function and a computer-aid function, is equipped with an Internet function while faithfully performing the broadcast receiving function, and equipped with an easy-to-use interface such as a handwriting input device, a touch screen, or a space remote control. In addition, due to the support of the wired or wireless Internet function, the video transmitting device accesses the Internet and a computer to perform a function such as an e-mail, web-browsing, banking, or game. A standardized general-purpose operating system (OS) may be used for these various functions.

Therefore, in the video transmitting device described in the present invention, since various application may be freely added or deleted on a general-purpose operating system (OS) kernel, various user-friendly functions may be performed.

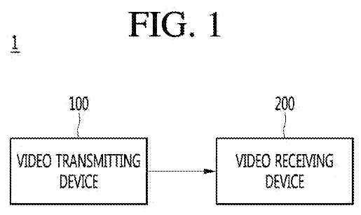

FIGS. 1 to 3 are views illustrating a configuration of a display system according to an embodiment of the present invention.

Referring to FIG. 1, a display system 1 according to an embodiment of the present invention includes a video transmitting device 100 and a video receiving device 200.

The video transmitting device 100 may be a device capable of encoding a content image and wirelessly transmitting the encoded content image.

The video receiving device 200 may be a display device capable of wirelessly receiving the encoded content and decoding the received content.

The video transmitting device 100 and the video receiving device 200 may constitute a video wall display system.

In a video wall, having a thin bezel in the display plays an important role in visualizing the content image. For the thin bezel of the display, it is efficient that only the components for the minimum function are provided, and the circuitry or components for the main function are received in a separate device.

The video transmitting device 100 may determine the type of the content image input from the outside and determine the compression ratio of the content image based on the determined type. The compression ratio of the content image may indicate a ratio of compressing the data size of the content image.

The video transmitting device 100 may compress the content image according to the determined compression ratio, and may transmit the compressed content image to the video receiving device 200 wirelessly.

The video receiving device 200 may recover the compressed content image received from the video transmitting device 100 and display the recovered content image on the display.

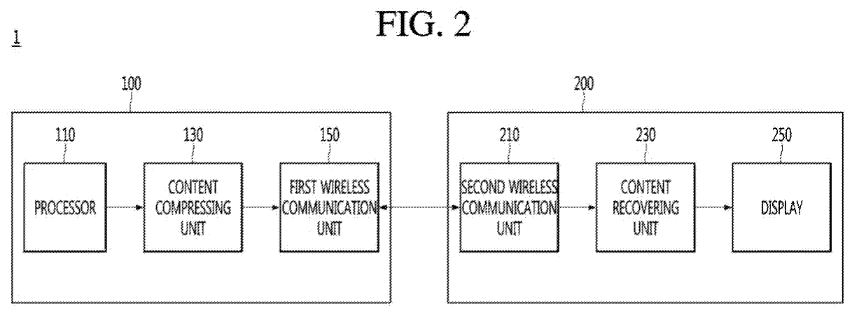

FIG. 2 is a block diagram illustrating the detailed configuration of the video transmitting device 100 and the video receiving device 200.

Referring to FIG. 2, the video transmitting device 100 may include a processor 110, a content compressing unit 130, and a first wireless communication unit 150.

The processor 110 may control the overall operation of the video transmitting device 100. The processor 110 may be configured as a system on chip (SoC).

The processor 110 may determine the compression ratio according to the type of the content image, and may transmit at least one of audio or video to the content compressing unit 130 according to the determined compression ratio.

The processor 110 may extract a logo image from the entire content image including the logo image and the content image. The content image may be a remaining image of the entire content image other than a portion that the logo image is displayed.

The processor 110 may determine the compression ratio of the logo image at a second compression ratio that is greater than a first compression ratio of the content image, thereby lowering the resolution of the logo image to the resolution of the content image.

The content compressing unit 130 may compress the content image at the first compression ratio and the extracted logo image at the second compression ratio.

The content compressing unit 130 may compensate for the dis connection of the content image or wireless communication by changing the compression ratio of the content image according to the wireless quality. The content image may include one or more of audio (Audio) or video (Video).

When the wireless quality is low, the content compressing unit 130 may decrease a data transmission rate (which means that the compression ratio is increased).

When the radio quality is high, the content compressing unit 130 may increase the data transmission rate (which means that the compression ratio is decreased).

The content compressing unit 130 may be referred to as an encoder.

The first wireless communication unit 150 may wirelessly transmit the content image compressed by the content compressing unit 130 to the video receiving device 200.

The first wireless communication unit 150 of the video transmitting device 100 transmits the content image compressed at the first compression ratio and the logo image compressed at the second compression ratio to the second wireless communication unit 210 of the video receiving device 200.

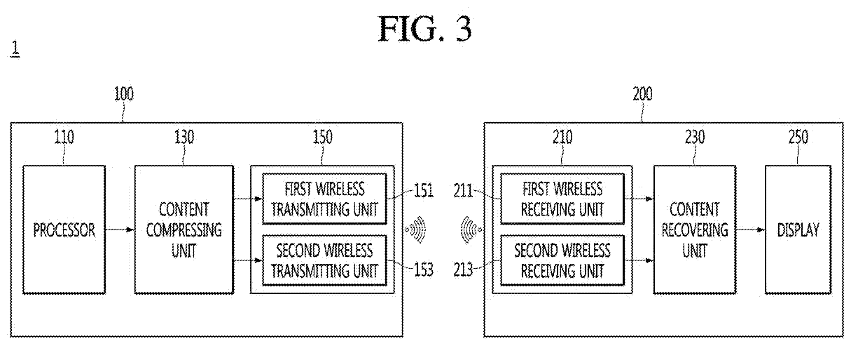

Referring to FIG. 3, the first wireless communication unit 150 may include a first wireless transmitting unit 151 and a second wireless transmitting unit 153.

The first wireless communication unit 150 may transmit the compressed content image to the second wireless communication unit 210 of the video receiving device 200 through two channels.

Each of the first wireless transmitting unit 151 and the second wireless transmitting unit 153 transmits the compressed content image to the first wireless receiving unit 211 and the second wireless receiving unit 213 of the video receiving device 200.

According to one embodiment, two channels are used to transmit the compressed content image through a channel with more excellent wireless quality, thereby reducing a transmission delay.

According another embodiment, the reason why two channels is to divide and transmit the content image through two channel since the data capacity is large in the case of a content image having a 4K resolution.

Each of the first wireless transmitting unit 151 and the second wireless transmitting unit 153 may include a baseband module for baseband communication and a radio frequency (RF) module for RF communication.

The baseband module may generate low frequency band data, which is not modulated, for the compressed content image and transmit the lower frequency band data to the RF module.

The RF module converts data in a low frequency band into data in a high frequency band according to an RF communication standard, and transmits the data for the converted content image to the video receiving device 200.

The video receiving device 200 may include a second wireless communication unit 210, a content recovering unit 230, and a display 250.

The second wireless communication unit 210 may include a first wireless receiving unit 211 and a second wireless receiving unit 213.

In other words, the second wireless communication unit 210 may also include two channels.

Each of the first wireless receiving unit 211 and the second wireless receiving unit 213 may include a baseband module for baseband communication and an RF module for RF communication.

The RF module may receive data in a high frequency band from the video transmitting device 100 according to the RF (Radio Frequency) communication standard.

The baseband module may convert data in the high frequency band into data in the low frequency band.

The content recovering unit 230 may decode the content image received through the second wireless communication unit 210.

The content recovering unit 230 may recover the compressed content image into a content image having an original size.

The content recovering unit 230 may be referred to as a decoder.

The display 250 may display the recovered content image.

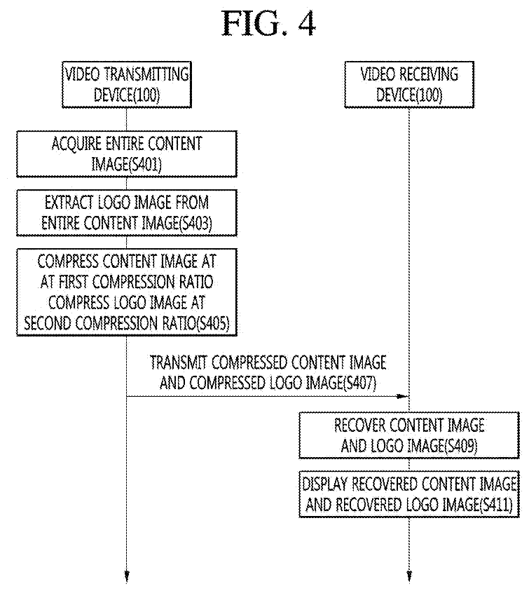

FIG. 4 is a ladder diagram illustrating a method for operating a display system according to an embodiment of the present invention.

The processor 110 of the video transmitting device 100 acquires the entire content image (S401).

According to one embodiment, the video transmitting device 100 may receive a content image through an external interface.

The external interface may include an external input terminal such as a high definition multimedia interface (HDMI).

According to another embodiment, the video transmitting device 100 may acquire the content image through the internal storage.

The entire content image may include a content image and a logo image.

The logo image may include at least one of the source of the content image and the title of the content image.

The processor 110 of the video transmitting device 100 extracts the logo image from the obtained entire content image (S403).

The logo image may be an image including a logo displayed continuously on a fixed position of the content image.

The logo image may be identified as a logo region having the shape of a rectangle, but this is provided for the illustrative purpose.

According to one embodiment, the processor 110 may determine whether the content image is a moving picture. This is because, if the content image is a still image, the extraction of the logo image is meaningless.

The processor 110 may extract the logo image from the content image when it is determined that the content image is a moving picture.

The processor 110 may detect a region having no variation at the fixed position for a predetermined period of time from the moving image, and extract the image of the detected region as a logo image.

To extract the logo image, the processor 110 may compare the similarity between a plurality of image frames constituting the moving picture with the passage of time.

The processor 110 may extract an image, which corresponds to a region having no variation at a fixed position for a predetermined time period, as a logo image according to the comparison result.

According to one embodiment, there may be one or more logo images on the content image.

The processor 110 of the video transmitting device 100 compresses the content image at the first compression ratio and the extracted logo image the a second compression ratio (S405).

According to one embodiment, the first compression ratio may be ⅙ times the data size of the entire original content image, and the second compression ratio may have the range from more than ⅙ times to at most 1/10 times the data size of the entire original content image.

The processor 110 may determine the compression ratio of the logo image at the second compression ratio that is greater than the first compression ratio of the content image, to reduce the resolution of the logo image to the resolution of the content image.

The logo image may be arranged adjacent to the vertex on a screen having the shape of the rectangle. A viewer watching the content image is more interested in the content image rather than the logo image. Thus, even if the resolution of the logo image displayed by the video receiving device 200 is low, the viewer may not feel a great inconvenience in viewing the content image.

When the compression ratio of the logo image is increased more than the compression ratio of the content image, the sharpness of the logo image is lowered (or the peaking is reduced), and the residual image of the logo image is reduced. The details thereof will be described.

According to one embodiment, the processor 110 may adjust the second compression ratio of the logo image, based on the wireless quality state.

For example, the processor 110 may increase the second compression ratio of the logo image when the wireless quality state is greater than or equal to the reference quality. For example, when the wireless quality state is equal to or higher than the reference quality, the processor 110 may determine the second compression ratio of the logo image to be 1/10 times the data size of the entire original content image.

To the contrary, the processor 110 may reduce the second compression ratio of the logo image when the wireless quality state is less than the reference quality. For example, when the wireless quality state is less than the reference quality, the processor 110 may determine the second compression ratio of the logo image to be 1/7 times the data size of the original entire content image.

Meanwhile, the processor 110 may determine the wireless quality state based on a packet error.

For example, when the detected packet error ratio is equal to or greater than a preset ratio, the video receiving device 200 may determine that the wireless quality is inferior, and when the detected packet error ratio is less than the preset ratio, the video receiving device 200 may determine that the wireless quality is superior.

According to another embodiment, the video receiving device 200 may determine the state of the wireless quality using the data reception sensitivity.

For example, when the data reception sensitivity is equal to or higher than specific sensitivity, the video receiving device 200 may determine that the wireless quality is superior. When the data reception sensitivity is less than the specific sensitivity, the video receiving device 200 may determine that the wireless quality is inferior.

The video receiving device 200 may transmit information on the state of the wireless quality to the video transmitting device 100 and the video transmitting device 100 may adjust the second compression ratio of the logo image, based on the received information on the state of the wireless quality.

The first wireless communication unit 150 of the video transmitting device 100 transmits the content image compressed at the first compression ratio and the logo image compressed at the second compression ratio to the second wireless communication unit 210 of the video receiving device 200 (S407).

The first wireless communication unit 150 may transmit data on the content image compressed at the first compression ratio and information on the content image to the second wireless communication unit 210.

The information on the content image may include at least one of brightness information of the content image, reproduction time of the content image, the type of the content image, the source of the content image, and the resolution of the content image.

The first wireless communication unit 150 may transmit the logo image compressed at the second compression ratio and the information on the logo image to the second wireless communication unit 210.

The information on the compressed logo image may include at least one of coordinate information of the logo region in which the logo image is displayed, the number of logo regions, and a display period of the logo region, in all content images.

The content recovering unit 230 of the video receiving device 200 recovers the received content image and the logo image (S409).

According to one embodiment, the content recovering unit 230 may recover the data size of the content image compressed at the first compression ratio to the original data size, and may recover the data size of the logo image compressed at the second compression ratio to the original data size.

The content recovering unit 230 may release the compression of the content image. This may be named a decoding process.

The display 250 of the video receiving device 200 displays a recovered content image and a recovered logo region (S411).

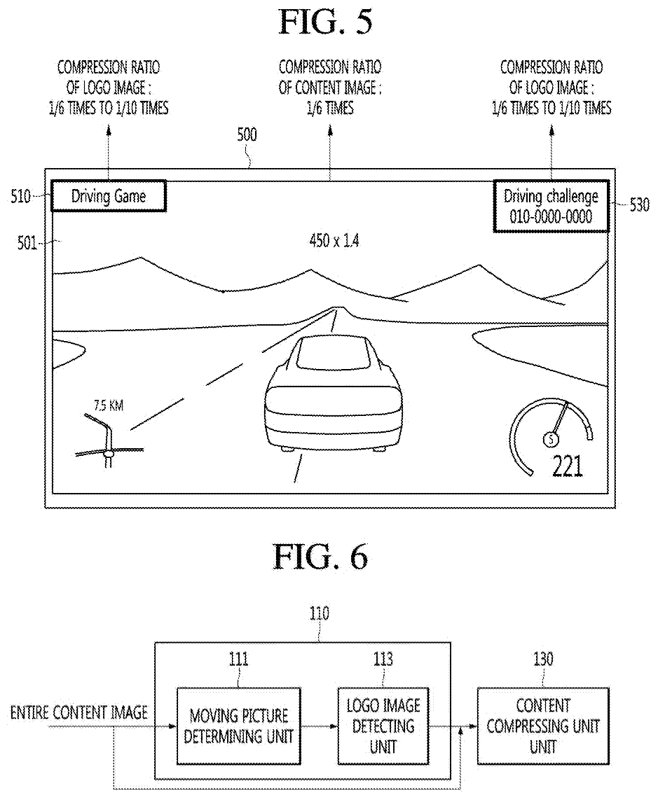

FIG. 5 illustrates an example of a logo image located on an entire content image.

Referring to FIG. 5, an entire content image 500 may include a content image 501, and a first logo image 510 and a second logo image 530 displayed in overlap with on the content image 501.

The processor 110 of the video transmitting device 100 may determine whether the entire content image 500 is a moving picture.

The processor 110 may determine which image is a logo image from the entire content image 500 when the entire content image 500 is determined as the moving picture.

According to one embodiment, the processor 110 may determine a relevant image as the logo image when there is no change in the screen at a fixed position in the entire content image 500 for a predetermined period of time.

The processor 110 may obtain information on the determined logo image.

The information on the logo image may include the coordinates of the logo region including the logo image, the display period of the logo image, and the number of logo images.

As illustrated in FIG. 5, the processor 110 may extract the first logo image 510 and the second logo image 530 from the entire content image 500.

The processor 110 may compress the content image 501 to have a size of ⅙ times the data size of the original content image.

The processor 110 may compress the first logo image 510 and the second logo image 530 at a compression ratio in a range of more than ⅙ times to at most 1/10 times the data size of the content image 501.

As described above, the processor 110 may compress the content image 501 and the logo image at different compression ratios, respectively.

This is to lower the resolution of the logo image by making the compression ratio of the logo image greater than the compression ratio of the content image 501. When the resolution of the logo image is lowered, the sharpness of the logo image is reduced, and the residual image of the logo image may be reduced.

In view of the user, the user's interest is the content image 501, and not a logo image. Accordingly, even if the definition of the logo image is reduced, the user may not feel a great inconvenience in viewing.

According to another embodiment of the present invention, the compression ratios of the first logo image 510 and the second logo image 530 may be set to different values.

For example, the processor 110 may determine the compression ratios based on the occupation size of the first logo image 510 on the occupation screen and the size of the second logo image 530 on the screen.

For example, when the size of the logo region of *?*the first logo image 510 is smaller than the size of the logo region of *?*the second logo image 510, the compression ratio of the first logo image 510 is set to be greater than the compression ratio of the second logo image 530.

This is because, when the logo region of *?*the logo image is small, even if the resolution is more lowered by increasing the compression ratio, the logo legion may be hardly viewed by the viewer.

FIG. 6 is a view illustrating a process of extracting and compressing a logo image from an entire content image according to an embodiment of the present invention.

Referring to FIG. 6, the processor 110 of the video receiving device 100 may include a moving picture determining unit 111 and a logo image detecting unit 113.

The moving picture determining unit 111 may determine whether an entire content image is a moving picture or a still image.

The moving picture determining unit 111 may detect an object included in the entire content image and the motion of the object, thereby determining whether the entire content image is the moving picture.

The moving picture determining unit 111 may determine whether there is the movement of the object using the motion vector.

When a motion vector value of the object is changed, the moving picture determining unit 111 may determine the type of the content image as a moving picture.

When the motion vector value of the object is fixed, the moving picture determining unit 111 may determine the type of the content image as a still image.

The logo image detecting unit 113 may detect a logo image from the entire content image, and may separate the logo image from the entire content image.

The logo image detecting unit 113 may detect, as the logo image, an image existing in a fixed position for a predetermined time from the entire content image.

The logo image detecting unit 113 may extract one or more logo images from the entire content image.

The logo image detecting unit 113 generates logo image information including data on a logo image, the coordinates of the logo region in which the logo image is displayed, the number of logo images, a text represented by the logo image, and the display period of the logo image, and may transmit the generated information on the logo image to the content compressing unit 130.

The content compressing unit 130 may compress the information on the logo image information at the second compression ratio.

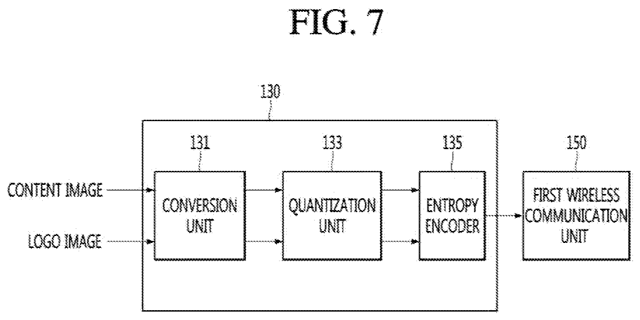

FIG. 7 is a view illustrating a process of compressing a content image and a logo image according to an embodiment of the present invention.

Referring to FIG. 7, the content compressing unit 130 may include a conversion unit 131, a quantization unit 133, and an entropy encoder 135.

The conversion unit 131 may perform wavelet transformation on each of the content image and the logo image.

The wavelet transformation refers to transforming a data vector of an image into another numerical vector. In the wavelet transformation process, the data vector of the original image may be transformed into another numerical vector by using the compression ratio.

Since the wavelet transformation is a well-known technology, the details thereof will be omitted.

The quantization unit 133 may quantize the wavelet transformation result for each of the content image and the logo image.

The quantization unit 133 may be a process of changing the data of the wavelet transformation result into discrete data.

The entropy encoder 135 may code a code having the same length for a symbol of the quantized data into codes having mutually different lengths proportional to a negative logarithm of a probability value of the symbol.

The output data of the entropy encoder 135 may be transmitted to the first wireless communication unit 150.

The output data of the entropy encoder 135 includes data of the compressed content image, data including information on the compressed content image, data of the compressed logo image, and data including information on the compressed logo image.

Meanwhile, the image reconstruction process may be performed in the reverse order to the order illustrated in FIG. 7.

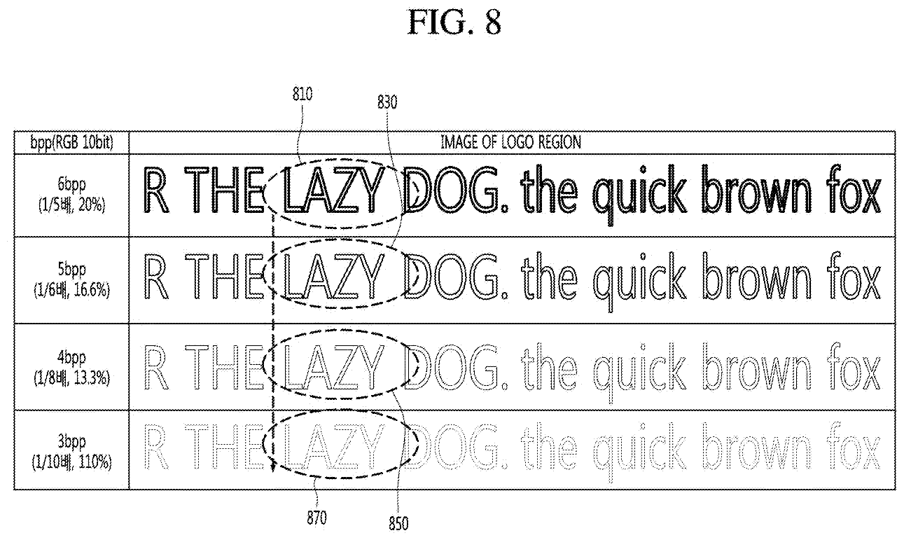

FIG. 8 is a view illustrating the actual change of a logo image when the compression ratio of the logo image is varied, according to an embodiment of the present invention.

In FIG. 8, a description will be made with reference to text <LAZY> among images included in the logo region.

In addition, in FIG. 8, it is assumed that no change is made for the brightness of the logo region including the logo image.

Referring to FIG. 8, a first compressed logo image 810 obtained by compressing the logo image at ⅕ times the compression ratio of the entire original content image, a second compressed logo image 830 obtained by compressing the logo image at ⅙ times the compression ratio of the entire original content image, a third compressed logo image 850 obtained by compressing the logo image at ⅛ times the compression ratio of the entire original content image, and a fourth compressed logo image 870 obtained by compressing the logo image at 1/10 times the compression ratio of the entire original content image,

In FIG. 8, “bpp” represents bits per pixel

As illustrated in FIG. 8, it may be recognized that the resolution of the text is decreased as the compression ratio for the logo image is increased. When the resolution of the text is decreased, the definition of the text is lowered, so the residual image of the logo image is reduced.

In particular, the residual image, which is to be generated on the display of the video receiving device 200, may be improved as the resolution is reduced around a logo text of the logo image included in the logo region.

According to an embodiment of the present invention, the above-described method may be implemented with codes readable by a processor in a medium having program. The medium having the program is, for example, a read only memory, a random access memory, a CD-ROM, a magnetic tape, a floppy disk, or an optical data storage.

The video transmitting device described above is not limited to components and methods of the above-described embodiments, and the entire portion or a portion of the embodiments are selectively combined such that the embodiments have variations.

1. A video transmitting device comprising:
a processor configured to extract a logo image from an entire content image, when the entire content image including a content image and the logo image is a moving picture, and to determine a compression ratio of the content image to be a first compression ratio and a compression ratio of the logo image to be a second compression ratio higher than the first compression ratio;
a content compressing unit configured to compress the entire content image at the first compression ratio and to compress the logo image at the second compression ratio, based on the determined compression ratio; and
a wireless communication unit configured to wirelessly transmit the compressed content image and the compressed logo image to a video receiving device.

2. The video transmitting device of claim 1, wherein the processor is configured to:
determine the second compression ratio, based on a wireless quality state between the video transmitting device and the video receiving device.

3. The video transmitting device of claim 2, wherein the processor is configured to:
increase the second compression ratio when the wireless quality state is equal to or greater than reference quality; and
decrease the second compression ratio when the wireless quality state is less than the reference quality.

4. The video transmitting device of claim 1, wherein the processor is configured to:
determine, as the logo image, an image continuously displayed at a fixed position for a specific period of time, in image frames constituting the entire content image.

5. The video transmitting device of claim 1, wherein the processor is configured to:
detect a motion vector value of an object included in the entire content image; and
determine a type of the entire content image as a moving picture, when the detected motion vector value is changed.

6. The video transmitting device of claim 1, wherein the first compression ratio is ⅙ times a data size of the entire content image, and
wherein the second compression ratio is more than ⅙ times and at most 1/10 times the data size of the entire content image.

7. The video transmitting device of claim 1, wherein the processor is configured to:
when extracting a first logo image and a second logo image from the entire content image,
determine a compression ratio of the first logo image and a compression ratio of the second logo image, based on sizes of the first logo image and the second logo image.

8. A method for operating a video transmitting device, the method comprising:
extracting a logo image from an entire content image, when the entire content image including a content image and the logo image is a moving picture;
determining a compression ratio of the content image to be a first compression ratio and a compression ratio of the logo image to be a second compression ratio higher than the first compression ratio;
compressing the content image at the first compression ratio and the logo image at the second compression ratio, based on the determined compression ratio; and
wirelessly transmitting the compressed content image and the compressed logo image to a video receiving device.

9. The method of claim 8, wherein the determining of the second compression ratio includes:
determining the second compression ratio, based on a wireless quality state between the video transmitting device and the video receiving device.

10. The method of claim 9, wherein the determining of the second compression ratio, based on the wireless quality state includes:
increasing the second compression ratio when the wireless quality state is equal to or greater than reference quality; and
decreasing the second compression ratio when the wireless quality state is less than reference quality.

11. The method of claim 8, further comprising:
determining, as the logo image, an image continuously displayed at a fixed position for a specific period of time, in image frames constituting the entire content image.

12. The method of claim 8, further comprising:
detecting a motion vector value of an object included in the entire content image; and
determining a type of the entire content image as a moving picture, when the detected motion vector value is changed.

13. The method of claim 8, wherein the first compression ratio is ⅙ times a data size of the entire content image, and
wherein the second compression ratio is more than ⅙ times and at most 1/10 times the data size of the entire content image.

14. The method of claim 8, further comprising:
when a plurality of logo images are extracted from the entire content image,
determining a compression ratio of each logo image, based on a size occupied by the plurality of logo images on a screen.
